(19) United States
(12) Patent Application Publication
(10) Pub. No.: US 2005/0002753 A1
(43) Pub. Date: Jan. 6, 2005

(54) Rotary fastener, fastenable material, fastener system, and storage system

(76) Inventor: James R. Haas, Bridgewater, NJ (US)

Correspondence Address: CONRAD R. LEIKAUF, ESQ., 3 FREWERT LANE, BRANCHBURG, NJ, 08876, US

(21) Appl. No.: 10/772,662

(22) Filed: Feb. 5, 2004

Related U.S. Application Data
(60) Provisional application No. 60/484,841, filed on Jul. 3, 2003.

(51) Int. Cl. F16B 21/00

(52) U.S. Cl. 411/349

(57) ABSTRACT

A short turn rotary fastener that comprises a helical prong, a fastenable material that comprises a prong receptor, a fastener system that comprises a short turn rotary fastener and a fastenable material, and a storage system comprised of a short turn rotary fastener and fastenable materials in the form of a shelf and a support. The prong can be self-tapping to allow for the absence of a prong receptor in a material. A prong can have a thickened portion to limit the penetration of the fastener into the material. Multiple prongs may be joined by a connector. The fastener may have a rotating mechanism such as a shape change metal or a lever to engage or disengage the fastener. A fastenable material can be a variety of items such as a block, a bar, a connector, or a support piece.

### BACKGROUND OF THE INVENTION

A common type of rotary fastener is the inclined plane wrapped around a central shaft. This fastener usually requires many full rotations to fasten. One of these, commonly called a wood screw, has a taper.

There are fasteners that utilize a tooth or non-helical prong. They may require a backing piece to deform them into a rounded non-helical shape.

There is a design for the male members of a fastener that uses hooks for surface mounting, and, while rounded, are not helically shaped.

Other rotary fasteners are short turn types, designed so that they can be engaged or disengaged with a short rotation about their insertion axis, frequently a quarter turn. Some fasteners require the fastener to engage a backing piece to hold the materials together. Some require a thick shaft. Some fasteners utilize a mixture of flexible or resilient appendages attached to a carrier such as a key, stud, pin, or bolt that goes through an opening in the joinable material. This opening is sometimes referred to as a keyway, passage, cavity, or socket. These openings in the materials to be fastened are large in size compared to the appendage to allow for the carrier.

A washer, grommet, or similar device is frequently used to spread the compression load and keep the fastener from crushing the materials being fastened, while the carrier sustains the transverse forces.

Some of the problems of the prior art are that some fasteners can require multiple turns. Some are not scalable. Some require a backing piece. Some are for surface to surface connection only. Many require a large opening in the material to be fastened to allow for the carrier.

### SUMMARY AND BRIEF DESCRIPTION

This discovery solves one or more of the problems of the prior art. Other advantages will be apparent.

The present disclosure teaches a scalable, short turn rotary fastener employing a helical prong subject to the definitions below. The term “short turn” means a rotation of 360 degrees or less. Thus, the term “short turn rotary fastener” means a fastener that requires a rotation of 360 degrees or less to fully engage or disengage and typically is a quarter-turn fastener. Also disclosed is a material having a receptor for a prong. The prong and the material with a prong receptor comprise a fastener system.

A helix can be defined as a curve for which the tangent makes a constant angle with a fixed line. One skilled in the art could deviate from an exact helix and still be within the teachings of this disclosure. The terms “helix” and “helical” in reference to the subject of the present teaching, throughout this disclosure including claims and descriptions of the drawings, unless otherwise noted, means a shape within about 25% of the maximum value of an exact helix. While an exact helix will have an exact constant angle, the constant angles in the subject of the present disclosure may have a variation.

For example, the formula for an exact helix centered upon the z axis is x=a cos Θ, y=a sin Θ and z=b Θ where a and b are constants and Θ is in radians. For real dimensions, we will use the absolute values of the trigonometric functions. For a quarter-turn fastener, the sine and cosine vary from 0 to 1. Since a is a constant, the maximum value of x and y is therefore a. For a quarter-turn fastener, Θ varies from 0 to π/2 radians. Hence the maximum value of z is b*π/2. Similarly, for a ⅓ turn fastener, Θ=2π/3 radians, the maximum cosine is 1 and the maximum sine is 1. For a full turn fastener, Θ=2π radians, and the maximum sine and cosine are 1.

For a given amount of rotation, Θ, the constant angle the prong makes is related to the depth of the prong (z) and the distance from the axis of the helix (x and y). For a given z, increasing the length of the prong, that is increasing the maximum x and y, reduces the constant angle.

The amount of rotation required to engage a rotary fastener is dependent upon the length the prong must travel and the constant angle of the prong receptor.

Some of the considerations in determining the length of the prong are the depth of the materials to be fastened, the strength required of the prong, and the amount of rotation of the prong. The strength of the materials themselves can be the main sources of support. Over rotation of a fastener can be prevented by use of a prong connector. A thickened portion on a prong can limit the compression on a fastened material.

The term “prong” in reference to the subject of the present teaching, throughout this disclosure including claims and descriptions of the drawings, means a short turn, helical prong. The short turn rotary fastener can have a single prong or a plurality of prongs. The short turn rotary fastener can be a separate prong or be an integral part of the materials to be fastened. A plurality of prongs can be separate or connected to each other.

A fastenable material is a material that has a prong receptor. A prong receptor is an aperture region of a fastenable material that cooperates with a prong to allow the prong to be inserted into, and be engaged by, the fastenable material.

A fastener system is comprised of a rotary fastener and a fastenable material.

One skilled in the art should consider the stresses and strains, tension, compression and shear of the loads on the materials to be fastened including those exerted by a prong. The forces on a prong should be considered in selecting the composition of the prong. Another aspect that one skilled in the art should consider in selecting a suitable composition for the prongs is the amount of friction between the prong and the fastenable material. Multiple prongs can be used to spread the forces over a larger portion of the fastened materials, to increase the strength of the fastener, to distribute forces over more prongs and to increase the total amount of friction generated. A prong can be held in place in various ways including by a stop or by the prong receptor being slightly smaller than the prong. In designing a prong and prong receptor, one skilled in the art should consider the required degree of holding of the fastener by the prong receptor.

### DESCRIPTION OF THE DRAWINGS

These and other features, aspects, and advantages of the present invention will become better understood with regard to the following description, appended claims, and accompanying drawings, where:

FIG. 1A shows an embodiment of a short turn rotary fastener, a fastenable material, and a fastener system;

FIG. 1B shows the cooperation of a short turn rotary fastener and a fastenable material of FIG. 1A;

FIG. 2A shows an embodiment of a multi-prong short turn rotary fastener, a fastenable material with prong receptors in the shape of a conical well, and a fastener system;

FIG. 2B shows the cooperation of a multi-prong short turn rotary fastener and fastenable material of FIG. 2A;

FIG. 3A shows an embodiment of a multi-prong short turn rotary fastener where the prongs have a thick portion and a thin portion, fastenable materials with prong receptors of different sizes, and a fastener system;

FIG. 3B shows the cooperation of the multi-prong short turn rotary fastener and the fasteneable materials of FIG. 3A;

FIG. 4A shows an embodiment of a multi-prong short turn rotary fastener with a stop, fastenable materials, and a fastener system;

FIG. 4B shows the cooperation of the multi-prong short turn rotary fastener and the fasteneable materials of FIG. 4A;

FIG. 5A shows an embodiment of a multi-prong short turn rotary fastener, part of a fastener system, using a shape metal alloy wire and a spring for disengagement and engagement rotation and part of a fastener system;

FIG. 5B shows an embodiment of a fastenable material with the short turn rotary fastener of FIG. 5A mounted on the fastenable material;

FIG. 5C shows the cooperation of a short turn rotary fastener and the fastenable materials of FIG. 5B;

FIG. 5D shows the cooperation of the prongs of multiple short turn rotary fasteners and multiple fastenable materials of FIG. 5B, and part of a fastener system;

FIG. 6A shows an embodiment of a short turn rotary fastener, fastenable materials, a fastener system, and a storage system;

FIG. 6B shows the cooperation of the short turn rotary fastener and fasteneable materials of FIG. 6A;

FIG. 7A shows an embodiment of a multi-prong short turn rotary fastener with a lever for rotation;

FIG. 7B shows an embodiment of a fastenable material in the shape of a bracket;

FIG. 7C shows an embodiment of a fastener system using the short turn rotary fastener of FIG. 7A, the fastenable material of FIG. 7B, and an embodiment of a fastenable material in the form of a mounting strip; and,

FIG. 7D shows a cutaway view of the cooperation of the short turn rotary fastener and fastenable material of FIG. 7C.

### DETAILED DESCRIPTION

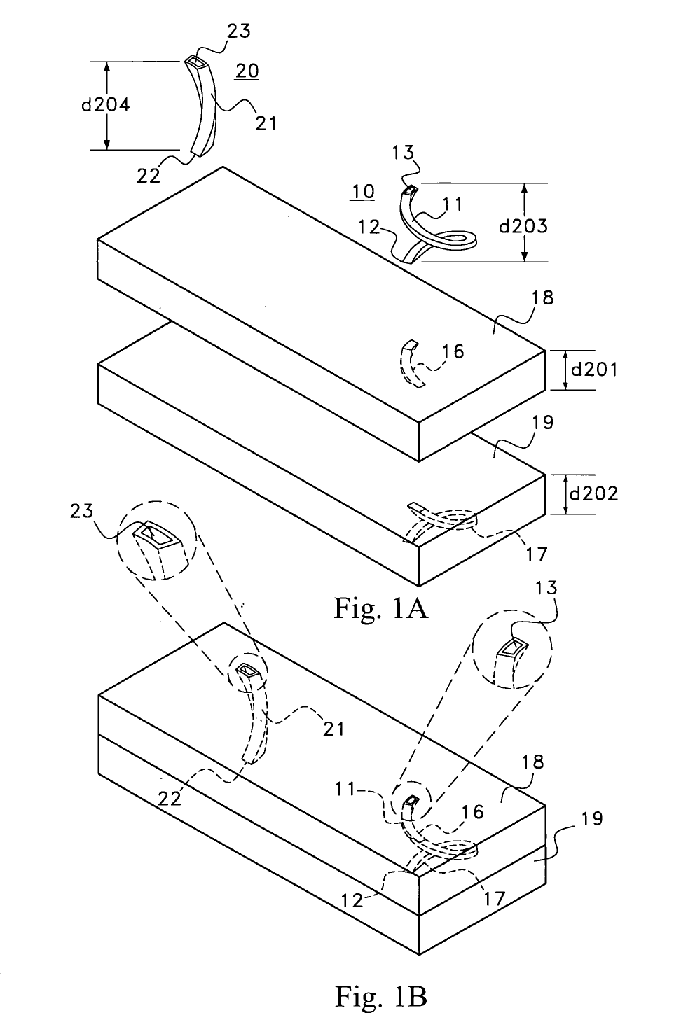

Referring to FIG. 1A, short turn rotary fastener 10 is a full turn fastener comprising a prong 11, a slotted cap 13, and a tip 12. When viewed along an axis from slotted cap 13 to tip 12, short turn rotary fastener 10 fastens in a counter-clockwise direction.

Short turn rotary fastener 20 is a quarter turn fastener comprising a prong 21, a slotted cap 23, and a tip 22. When viewed along an axis from slotted cap 23 to tip 22, short turn rotary fastener 20 fastens in a clockwise direction.

In this embodiment, tip 12 is a square point and tip 22 is a chisel point.

Still referring to FIG. 1A, fastenable material 18 comprises prong receptor 16, and fastenable material 19 comprises prong receptor 17. In this embodiment, both fastenable material 18 and fastenable material 19 are a soft material such as pine wood. Prong receptor 16 and prong receptor 17 are designed to cooperate with short turn rotary fastener 10 such that prong 11 can be inserted into, and engaged by, prong receptors 16 and 17. While there are many ways to retain a rotary fastener, in this embodiment prong receptor 16 and prong receptor 17 are sized slightly smaller than prong 11 to hold short turn rotary fastener 10 in place.

In this embodiment, short turn rotary fastener 10 is made of a flexible, resilient substance such as PVC. Further, prong 21 is of a sufficient strength and tip 22 is of a sufficient sharpness that short turn rotary fastener 20 is self-tapping with regards to fastenable materials 18 and 19 and in this embodiment is made of aluminum.

Fastenable material 18 has a depth d201 and fastenable material 19 has a depth d202. Short turn rotary fastener 10 has a depth d203 measured from the slotted cap 13 to the tip 12. Short turn rotary fastener 20 has a depth d204 measured from the slotted cap 23 to the tip 22. In this embodiment, the depth of short turn rotary fastener 10, that is d203, and the depth of short turn rotary fastener 20, that is d204, are approximately equal to the depth of the fastenable materials to be fastened, d201+d202. In this embodiment, d201 and d202 are approximately 3 inches each. Dimensions d203 and d204 are each approximately six inches.

Referring to FIG. 1B, fastenable materials 18 and 19 are aligned such that prong receptors 16 and 17 can receive prong 11. Tip 12 is placed on prong receptor 16 and rotated via slotted cap 13 into prong receptors 16 and 17. Tip 22 of short turn rotary fastener 20 is placed on fastenable material 18 with sufficient pressure to drive prong 21 into fastenable material 19 and then rotated a sufficient amount to join fastenable materials 18 and 19.

In this embodiment, by using counter-rotating short turn rotary fasteners 10 and 20, fastenable materials 18 and 19 are less likely to rotate apart.

Referring to FIG. 1A, an embodiment of a fastener system is comprised of short turn rotary fastener 10 and fastenable material 18. Another embodiment of a fastener system is comprised of short turn rotary fastener 10 and fastenable material 19.

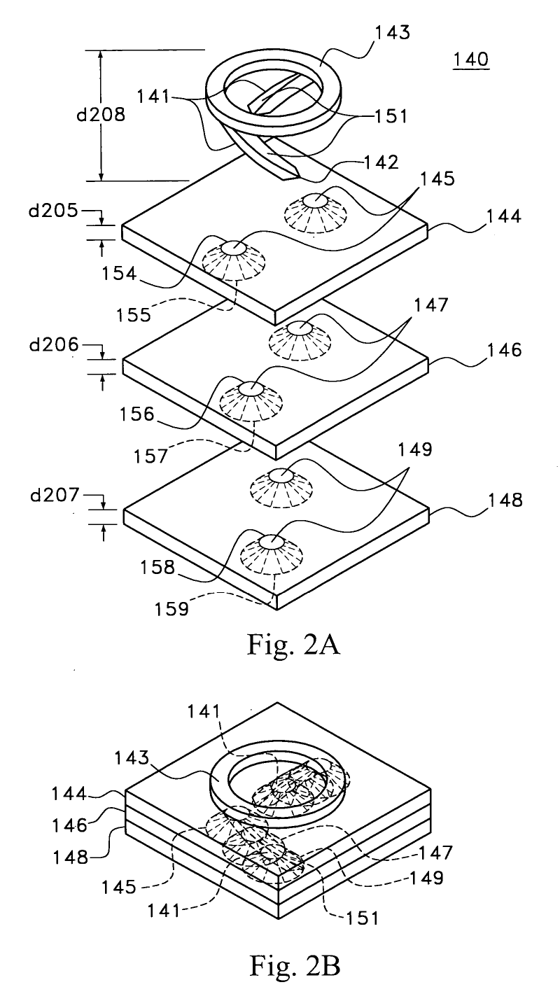

Referring to FIG. 2A, short turn rotary fastener 140 comprises a plurality of prongs 141 joined by a prong connector 143. Prong connector 143 is circular and allows the prongs 141 to be maneuvered simultaneously. Prongs 141 are comprised of a tip 142, leading surface 151. Leading surface 151 has a constant angle of 30 degrees prior to insertion. Prongs 141 have a depth d208. Prongs 141 are comprised of a flexible and resilient substance such as Acetal or PVC.

Fastenable material 144 has a depth d205 and is comprised of prong receptors 145 in the shape of a conical well. Fastenable material 146 has a depth d206 and is comprised of prong receptors 147 in the shape of a conical well. Fastenable material 148 has a depth d207 and is comprised of prong receptors 149 in the shape of a conical well. In this embodiment, d205, d206, and d207 are each about one millimeter. The d208 dimension is about three millimeters.

Prong receptor 145 has a narrow opening 154 and a wide opening 155. Prong receptor 147 has a narrow opening 156 and a wide opening 157. Prong receptors 145 and 147 have a constant angle of 30 degrees to allow prongs 141 to pass through. Prong receptor 149 has a narrow opening 158 and a wide opening 159 and has a constant angle of 30.1 degrees to exert a restraining force on prongs 141. Prong receptors 145, 147, and 149 are designed to cooperate with prongs 141 such that prongs 141 can be inserted into, and engaged by, prong receptors 145, 147, and 149.

Referring to FIG. 2B, prong receptors 145, 147, and 149 are aligned so that, when prongs 141 of short turn rotary fastener 140 are inserted in prong receptors 145 and rotated, prongs 141 engage, in succession, prong receptors 145, 147, and 149.

In operation, prongs 141 of fastener 140 are placed on the narrow openings of prong receptors 145. Light pressure is applied to prong connector 143 to seat the prongs 141 into prong receptors 145. Then prong connector 143 is rotated to cause the prongs 141 to advance through prong receptors 145, through prong receptors 147 and into prong receptors 149.

The leading surfaces 151 bear along the inside walls of prong receptors 145, 147, and 149 to provide sufficient friction to retain fastener 140 in fastenable materials 144, 146, and 148.

Referring to FIG. 2A, an embodiment of a fastener system is comprised of short turn rotary fastener 140 and fastenable material 144. Another embodiment of a fastener system is comprised of short turn rotary fastener 140 and fastenable material 146. Yet another embodiment of a fastener system is comprised of short turn rotary fastener 140 and fastenable material 148.

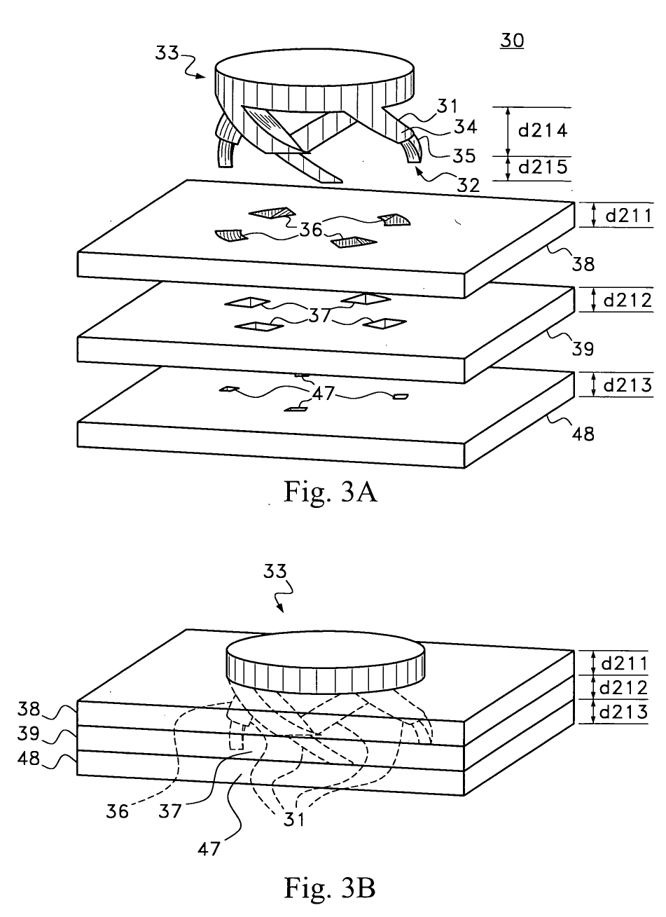

Referring to FIG. 3A, short turn rotary fastener 30 comprises a plurality of prongs 31 joined by a prong connector 33. Prong connector 33 is circular and allows the prongs 31 to be maneuvered simultaneously. Prongs 31 are comprised of a thick prong portion 34, a thin prong portion 35, and a tip 32. Thick prong portion 34 has a depth d214 and thin prong portion 35 has a depth d215.

Fastenable material 38 has a depth d211 and is comprised of prong receptors 36. Fastenable material 39 is compressible, has a depth d212, and is comprised of prong receptors 37. Fastenable material 48 has a depth d213 and is comprised of prong receptors 47.

Prong receptors 36, 37, and 47 are designed to cooperate with prongs 31. Prong receptors 36 and 37 are designed to cooperate with thick prong portion 34 and thin prong portion 35 such that, prongs 31 can be inserted into, and rotationally engaged, by prong receptors 36, 37, and 47. Prong receptors 47 are designed to cooperate with only the thin prong portion 35, limiting the penetration of prongs 31 into fastenable material 48.

Referring to FIG. 3B, prong receptors 36, 37, and 47 are aligned so that, when short turn rotary fastener 30 is inserted in prong receptor 36 and rotated, thin prong portion 35 passes through prong receptors 36 and 37 to engage prong receptor 47. Prong connector 33 serves as a stop to limit penetration of short turn rotary fastener 30 into fastenable materials 38, 39, and 48. The depth d214 of thick prong portion 34 is approximately equal to depths d211 plus d212 (d211+d212). Dimension d215 of thin prong portion 35 must be long enough to secure fastener 30 into fastenable material 48, and, in this embodiment, is approximately equal to d213.

Referring to FIG. 3A, an embodiment of a fastener system is comprised of short turn rotary fastener 30 and fastenable material 38. Another embodiment of a fastener system is comprised of short turn rotary fastner 30 and fastenable material 39. Yet another embodiment of a fastener system is comprised of short turn rotary fastner 30 and fastenable material 48.

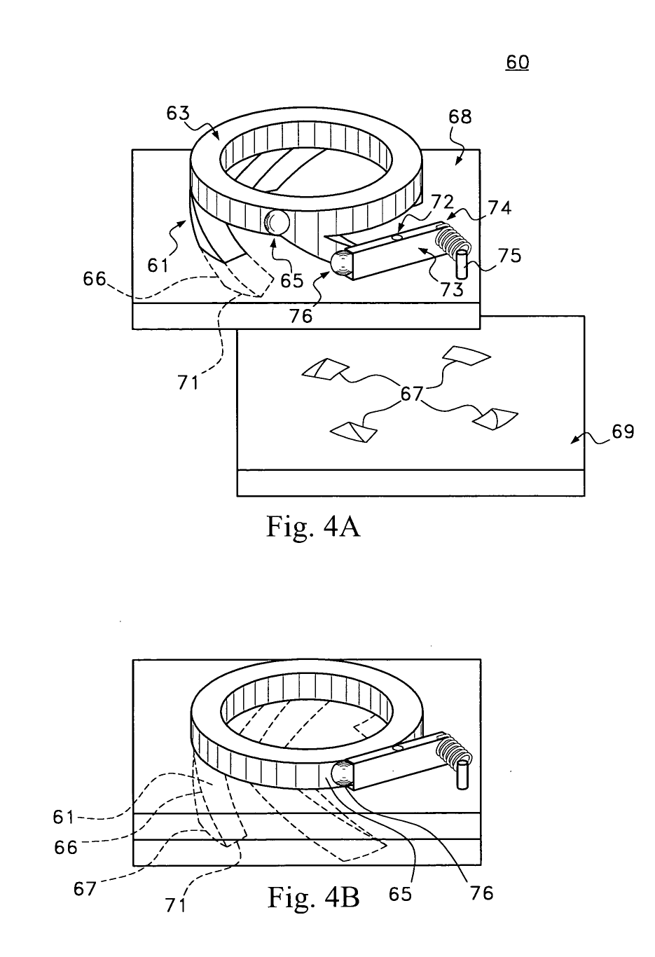

Referring to FIG. 4A, short turn rotary fastener 60 is comprised of a plurality of prongs 61 joined by a prong connector 63. Prong 61 is further comprised of a tip 71. In this embodiment, prong connector 63 can rotate all the prongs simultaneously.

Fastenable material 68 is comprised of a plurality of prong receptors 66 and fastenable material 69 is comprised of a plurality of prong receptors 67. Prong receptors 66 and 67 are designed to cooperate with prongs 61 such that when prong receptors 66 and 67 are aligned, prongs 61 can enter prong receptors 67 after passing through prong receptors 66.

Further comprising short turn rotary fastener 60 is a pivot 72, a pivot bar 73, a spring holder 75, and spring 74. Pivot 72 and spring holder 75 are mounted on fastenable material 68. Pivot bar 73 is mounted on pivot 72 and has a protrusion 76 opposite to spring 74 such that as prong connector 63 rotates, spring 74 causes pressure through pivot bar 73 on protrusion 76 towards prong connector 63. Protrusion 76 rides along a prong 61 and prong connector 63 until protrusion 76 and detent 65 are aligned. Spring 74 exerts pressure, through pivot bar 72, onto protrusion 76. Protrusion 76 and detent 65 serve as a stop retarding further rotation of prong connector 63.

Referring to FIG. 4B, prongs 61 are engaged by prong receptors 66 and 67. Protrusion 76 is engaged by detent 65.

Referring to FIG. 4A, an embodiment of a fastener system is comprised of short turn rotary fastener 60, fastenable material 68, and fastenable material 69.

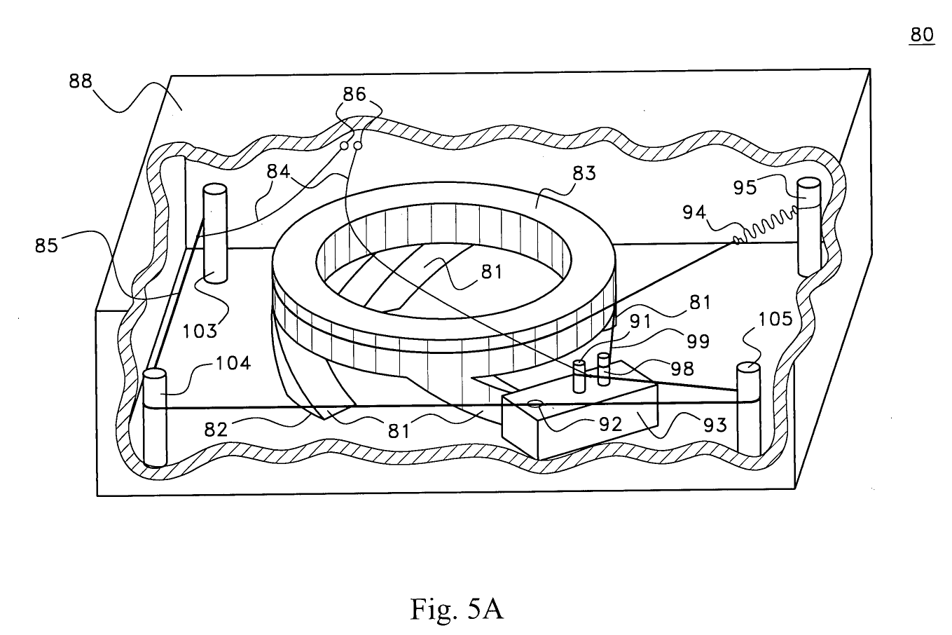

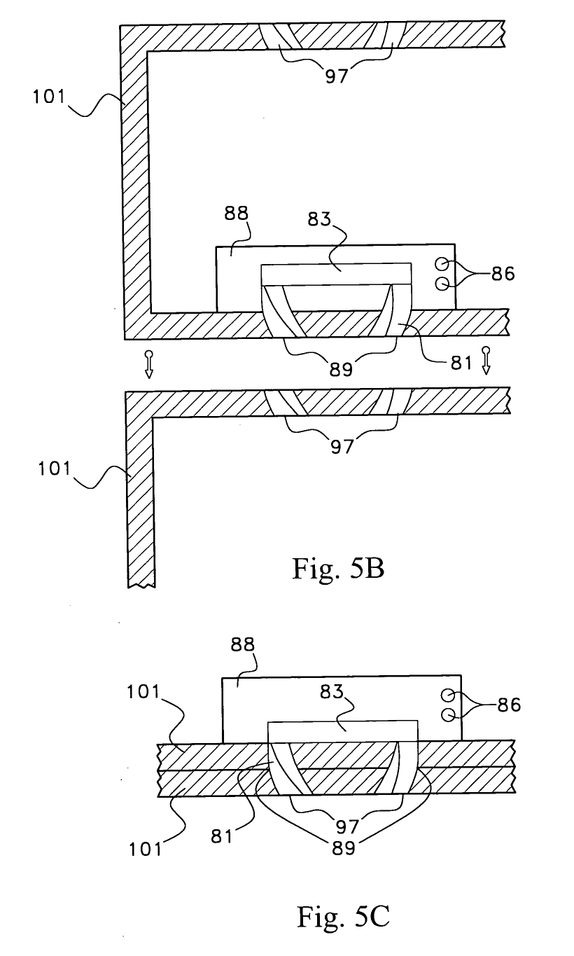

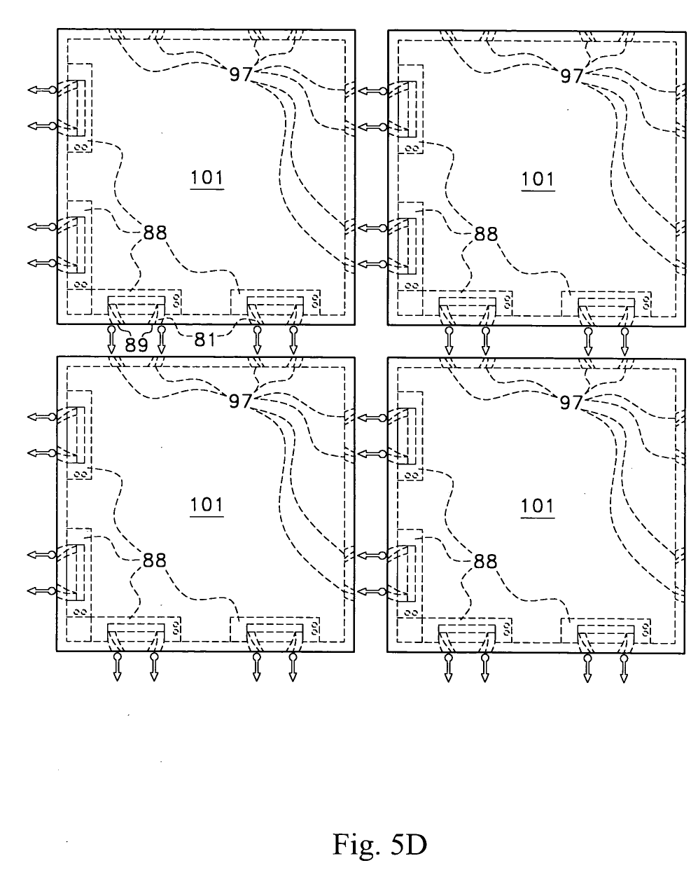

Referring to FIG. 5A, fastener case 88 encloses a short turn rotary fastener 80. Short turn rotary fastener 80 is comprised of a plurality of prongs 81 joined by a prong connector 83. Prong 81 is comprised of a tip 82. Prongs 81 are retracted and short turn rotary fastener 80 is shown in the energized or fastener disengaged position. Short turn rotary fastener 80 is further comprised of a pivot 92, a pivot bar 93, a connector pivot post 98, and a connector retractor 99. Pivot 92 is connected to fastener case 88. Shape metal pivot post 91 and connector pivot post 98 are mounted on pivot bar 93.

One skilled in the art can select a size and shape of a shape metal alloy to generate an appropriate force. In this embodiment, the shape metal alloy is a shape metal alloy wire 85. Short turn rotary fastener 80 is further comprised of jacks 86, an energizer wire 84, shape metal alloy wire 85, post 103, post 104, and post 105. Jacks 86 accept energizing power from an exterior source and provide it to energizer wire 84. Energizer wire 84 carries the energizing power from jacks 86 to shape metal alloy wire 85.

Shape metal alloy wire 85 is fixedly attached to post 103, extends around posts 104 and 105, and is fixedly attached to shape metal pivot post 91.

Shape metal alloy wire 85 is extended around posts 104 and 105 to increase its length so as to obtain the required amount of contraction. The selection of the composition of shape metal alloy wires is well known. One skilled in the art can determine the ratio of the major components and the additional additives to arrive at the desired features. In this embodiment, approximately equal amounts of nickel and titanium by number of atomic nuclei are used.

Still referring to FIG. 5A, rotation of prong connector 83 is accomplished in the following manner. Spring 94 is fixedly connected to post 95 and also to prong connector 83. Spring 94 normally contracts sufficiently to cause short turn rotary fastener 80 to be in the fastener engaged position. When energizing power is applied to jacks 86, the power is carried by energizing wire 84 to shape metal alloy wire 85. Shape metal alloy wire 85 heats and contracts. Shape metal alloy wire 85 is attached at one end to post 103. The contraction causes tension on pivot shape metal pivot post 91 and pivot bar 93 to retract. As pivot bar 93 retracts, connector pivot post 98 moves to increase clockwise tension on prong connector 83, causing prong connector 83 to rotate prongs 81 against the tension of spring 94. As shown in this figure, shape metal wire 85 is energized and the prongs 81 are retracted to the fastener disengaged position.

Referring to FIG. 5B, fastenable material 101, a structural piece, is comprised of fastener case 88, engaging prong receptor 89, and receiving prong receptor 97. Prongs 81 are in engaging prong receptors 89. Engaging prong receptors 89 are designed to cooperate with receiving prong receptors 97 to allow prongs 81 to pass through engaging prong receptors 89 into receiving prong receptors 97.

Referring to FIG. 5C, two sections of fastenable material 101 are mated and prongs 81 are engaged by receiving prong receptor 97 through engaging prong receptor 89. Inside fastener case 88 are prongs 81 connected by prong connector 83. Jacks 86 are not receiving energizing power and prongs 81 are extended in the engaged position.

Referring to FIG. 5D, fastenable materials 101 are aligned for joining. Inside fastener case 88, prongs 81 are retracted and engaged by engaging prong receptors 89. Engaging prong receptor 89 is aligned with a receiving prong receptor 97 to allow prongs 81 to be engaged by receiving prong receptor 97.

Referring to FIGS. 5A and 5D, an embodiment of a fastening system is comprised of short turn rotary fastener 80 and a fastenable material such as fastenable material 101.

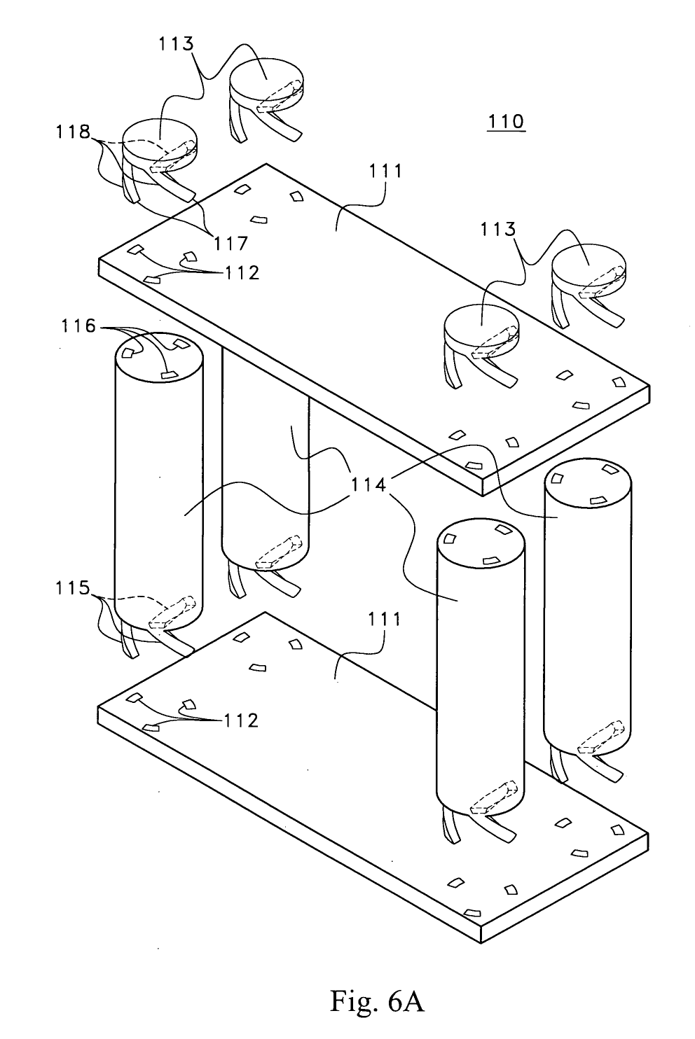

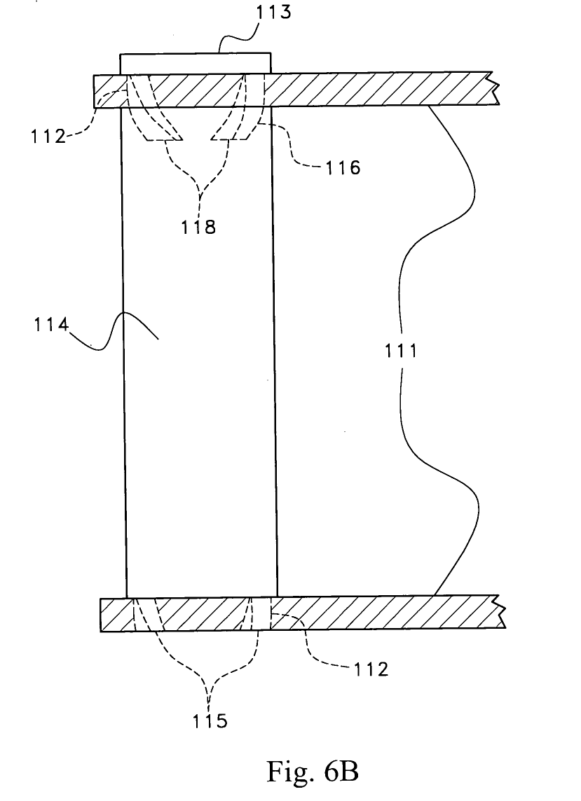

Referring to FIG. 6A, storage system 110 is comprised of a plurality of shelves 111, and a plurality of supports 114. Storage system 110 is further comprised of cap prong 118 and cap prong connector 113. Cap prong 118 is further comprised of a cap prong tip 117.

Shelf 111 is comprised of a plurality of shelf prong receptor 112. Support 114 is comprised of a plurality of support prongs 115 and a plurality of support prong receptors 116. Support prong 115 is further comprised of a support prong tip 119.

Shelf prong receptors 112 are designed to cooperate with support prongs 115 and cap prongs 118 such that prongs 118 can be inserted into, and rotationally engaged by, shelf prong receptors 112.

In this embodiment, shelf prong receptors 112 receive support prongs 115. Another shelf 111 is aligned over supports 114 such that shelf prong receptors 112 cooperate to allow cap prongs 118 to rotate through shelf prong receptors 112 into support prong receptors 116.

Referring to FIG. 6B, shelf prong receptors 112 of a shelf 111 engage support prongs 115 of support 114. Another shelf 111 is atop support 114 and aligned so that cap prongs 118 proceed through shelf prong receptors 112 and engage support prong receptors 116.

Referring to FIG. 6A, an embodiment of a fastener system according to this teaching is comprised of a cap prong 118 and a support 114. Another embodiment of a fastener system is comprised of a cap prong 118 and a shelf 111. Yet another fastener system according to this teaching is comprised of a support 114 and a shelf 111.

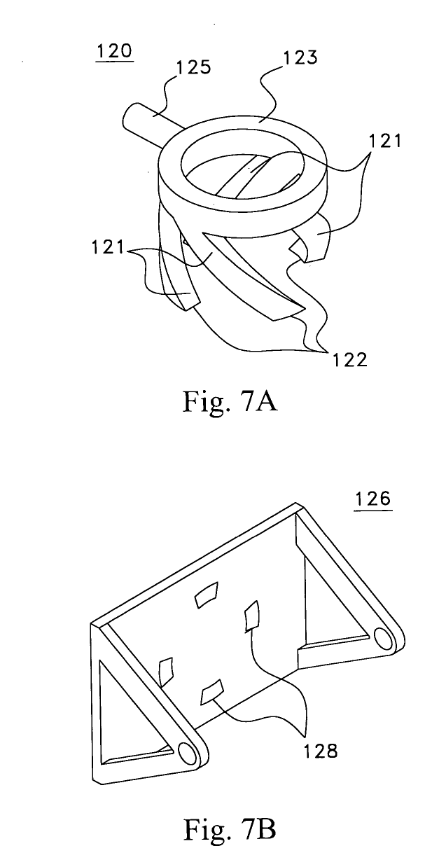

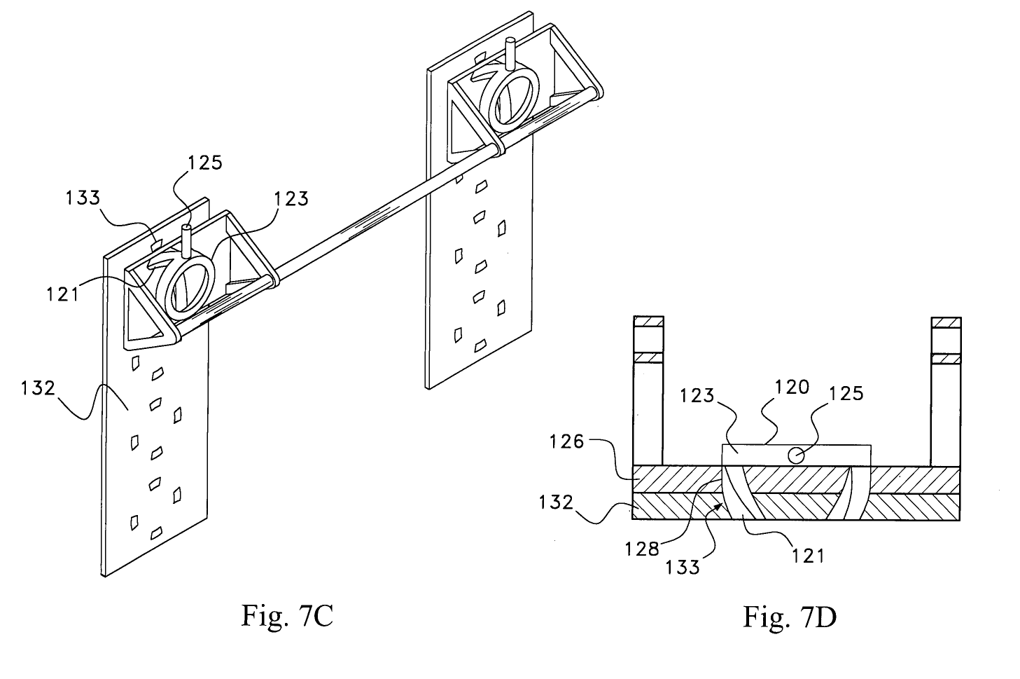

Referring to FIG. 7A, there is a short turn rotary fastener 120. Short turn rotary fastener 120 is comprised of a plurality of prongs 121, a prong connector 123, and a rotating mechanism 125. Prong 121 has a tip 122. Rotating mechanism 125 is attached to prong connector 123. In this embodiment, rotating mechanism 125 is a lever. Prong connector 123 allows the prongs 121 to be rotated with a single action.

Referring to FIG. 7B, bracket 126 is comprised of a plurality of bracket prong receptors 128.

Referring to FIG. 7C, there is a mounting strip 132 comprised of a plurality of mounting strip prong receptors 133. Bracket prong receptors 128 and mounting strip prong receptors 133 are designed to cooperate with prongs 121 such that prongs 121 can be inserted into and rotationally engage bracket prong receptors 128 and mounting strip prong receptors 133. The bracket prong receptors 128 of bracket 126 are aligned with the mounting strip prong receptors 133 of mounting strip 132. Prongs 121 of short turn rotary fastener 120 are positioned over bracket prong receptors 128. Rotating mechanism 125 rotates prong connector 123, causing prongs 121 to engage mounting strip prong receptors 133 through bracket prong receptors 128.

Referring to FIG. 7D, bracket 126 is fastened to mounting strip 132 by short turn rotary fastener 120. Prongs 121 engage bracket prong receptors 128 and mounting strip prong receptors 133.

Referring to FIG. 7C, an embodiment of a fastener system according to this teaching is comprised of short turn rotary fastener 120 and bracket 126. Another embodiment of a fastener system is comprised of short turn rotary fastener 120 and mounting strip 132.

While I have illustrated and described several embodiments of the invention, it should be apparent that changes and modifications may be made in the construction of the prong, the short turn rotary fastener or the prong receptor without departing from the spirit or scope of the invention. Accordingly, I do not desire to be limited to the exact construction shown and described. My invention should not be limited by the drawings.

1. A short turn rotary fastener comprising a short turn prong, the prong further comprising a tip.

2. A short turn rotary fastener as in claim 1 where the short turn is ¼ turn.

3. A short turn rotary fastener as in claim 1 where the short turn is ⅓ turn.

4. A short turn rotary fastener as in claim 1 where the short turn is one full turn.

5. A short turn rotary fastener as in claim 1 where the tip is self-tapping.

6. A short turn rotary fastener as in claim 1 where the tip is a chisel point.

7. A short turn rotary fastener as in claim 1 where the helix progresses in a clockwise direction.

8. A short turn rotary fastener as in claim 1 where the helix progresses in a counterclockwise direction.

9. A short turn rotary fastener as in claim 1 where the prong is rigid.

10. A short turn rotary fastener as in claim 1 where the prong is made of aluminum.

11. A short turn rotary fastener as in claim 1 where the prong is flexible.

12. A short turn rotary fastener as in claim 1 where the prong is made of PVC.

13. A short turn rotary fastener as in claim 1 where the prong is made of Acetyl.

14. A short turn rotary fastener as in claim 1 where the prong has a thick portion and a thin portion.

15. A short turn rotary fastener comprising
a prong, the prong being further comprised of:
(a) a tip; and
(b) a cap.

16. A short turn rotary fastener as in claim 15 where the cap is slotted.

17. A short turn rotary fastener comprising a plurality of prongs with:
(a) a prong that engages by rotation in a clockwise direction; and
(b) a prong that engages by rotation in a counter-clockwise direction.

18. A short turn rotary fastener comprising:
(a) a plurality of prongs; and
(b) a prong connector connecting the prongs.

19. A short turn rotary fastener as in claim 18 where the prong connector is further comprised of a detent.

20. A short turn rotary fastener as in claim 18 further comprised of a stop, where the stop being comprised of:
(a) a detent; and,
(b) a protrusion.

21. A short turn rotary fastener comprised of:
(a) a plurality of prongs;
(b) a prong connector connecting the prongs; and
(c) a rotation mechanism to rotate the prong connector.

22. A short turn rotary fastener as in claim 21 where the rotation mechanism is comprised of a shape metal alloy wire.

23. A short turn rotary fastener as in claim 21 where the rotation mechanism is comprised of a lever.

24. A fastenable material comprised of a prong receptor.

25. A fastenable material as in claim 24 where the prong receptor is a conical well.

26. A fastenable material as in claim 24 where the fastenable material is a shelf.

27. A fastenable material as in claim 24 where the fastenable material is a structural piece.

28. A fastenable material as in claim 24 where the fastenable material is a structural piece further comprised of a short turn rotary fastener, the short turn rotary fastener further comprised of a prong.

29. A fastenable material as in claim 24 where the fastenable material is a mounting bracket.

30. A fastenable material as in claim 24 where the fastenable material is a mounting strip.

31. A fastenable material as in claim 24 where the fastenable material is a support.

32. A fastenable material where the fastenable material is a support, the support comprised of a prong.

33. A support as in claim 32 where the support is further comprised of a prong receptor.

34. A storage system comprised of a plurality of supports and shelves:
(a) the support comprised of a prong and a prong receptor; and,
(b) the shelf comprised of a prong receptor.

35. A fastener system comprised of:
(a) a short turn rotary fastener comprised of a prong; and
(b) a fastenable material comprised of a prong receptor.

36. A fastener system as in claim 35 where the prong receptor is slightly smaller than the prong thereby exerting a retaining force.

37. A fastener system as in claim 35 where the prong receptor has a constant angle sufficiently different from the constant angle of the prong such that a retaining force between the prong receptor and the prong is created when the prong is engaged by the prong receptor, both constant angles within about 25% of the maximum value of a perfect helix.

38. A fastener system as in claim 35 where the short turn rotary fastener is a cap prong.

39. A fastener system as in claim 35 where the short turn rotary fastener is a support piece.

40. A fastener system as in claim 35 where the fastenable material is a structural piece.

41. A fastener system as in claim 35 where the fastenable material is a shelf.

42. A fastener system as in claim 35 where the fastenable material is a support.

43. A fastener system as in claim 35 where the fastenable material is a bracket.

44. A fastener system as in claim 35 where the fastenable material is a mounting strip.

45. A storage system comprised of:
(a) a plurality of shelves;
(b) a plurality of supports;
(c) a cap prong;
(d) a cap prong connector.
